(19) United States
(12) Patent Application Publication
(10) Pub. No.: US 2017/0057842 A1
(43) Pub. Date: Mar. 2, 2017

(54) Fluid Disinfection Using Ultraviolet Light

(71) Applicant: Sensor Electronic Technology, Inc., Columbia, SC (US)

(72) Inventors: Alexander Dobrinsky, Loudonville, NY (US); Michael Shur, Latham, NY (US)

(73) Assignee: Sensor Electronic Technology, Inc., Columbia, SC (US)

(21) Appl. No.: 15/254,161

(22) Filed: Sep. 1, 2016

Related U.S. Application Data
(60) Provisional application No. 62/212,593, filed on Sep. 1, 2015.

(51) Int. Cl. C02F 1/32; C02F 1/72; C02F 1/00

(52) U.S. Cl. CPC C02F 1/325; C02F 1/008; C02F 1/725; C02F 2209/11; C02F 2201/326; C02F 2305/10; C02F 2301/024; C02F 2301/022

(57) ABSTRACT

A fluid treatment system and method of treating fluid is described. The fluid treatment system can include a fluid transparency meter, which acquires data corresponding to an ultraviolet transparency of the fluid and a disinfection chamber within which a set of ultraviolet sources emit ultraviolet light onto the fluid located therein. The treatment system can include various features for mixing the fluid and/or recirculating the fluid for multiple ultraviolet light doses. A control system can manage a flow of the fluid through the fluid treatment system based on a disinfection dose delivered to the fluid.

### REFERENCE TO RELATED APPLICATIONS

The current application claims the benefit of co-pending U.S. Provisional Application No. 62/212,593, titled “Ultraviolet Water Disinfection System,” which was filed on 1 Sep. 2015, and which is hereby incorporated by reference.

### TECHNICAL FIELD

The disclosure relates generally to disinfection, and more particularly, to a solution for disinfecting a fluid, such as water, using deep ultraviolet light.

### BACKGROUND ART

Water treatment using ultraviolet (UV) radiation offers many advantages over other forms of water treatment, such as chemical treatment. For example, treatment with UV radiation does not introduce additional chemical or biological contaminants into the water. Furthermore, ultraviolet radiation provides one of the most efficient approaches to water decontamination since there are no microorganisms known to be resistant to ultraviolet radiation, unlike other decontamination methods, such as chlorination. UV radiation is known to be highly effective against bacteria, viruses, algae, molds and yeasts. For example, hepatitis virus has been shown to survive for considerable periods of time in the presence of chlorine, but is readily eliminated by UV radiation treatment. The removal efficiency of UV radiation for most microbiological contaminants, such as bacteria and viruses, generally exceeds 99%. To this extent, UV radiation is highly efficient at eliminating E-coli, Salmonella, Typhoid fever, Cholera, Tuberculosis, Influenza Virus, Polio Virus, and Hepatitis A Virus.

Intensity, radiation wavelength, and duration of radiation are important parameters in determining the disinfection rate of UV radiation treatment. These parameters can vary based on a particular target culture. The UV radiation does not allow microorganisms to develop an immune response, unlike the case with chemical treatment. The UV radiation affects biological agents by fusing and damaging the DNA of microorganisms, and preventing their replication. Also, if a sufficient amount of a protein is damaged in a cell of a microorganism, the cell enters apoptosis or programmed death. FIG. 1 shows an illustrative germicidal effectiveness curve of ultraviolet radiation according to the prior art. As illustrated, the most lethal radiation is at wavelengths of approximately 260 nanometers.

Ultraviolet radiation disinfection using mercury based lamps is a well-established technology. In general, a system for treating water using ultraviolet radiation is relatively easy to install and maintain in a plumbing or septic system. Use of UV radiation in such systems does not affect the overall system. However, it is often desirable to combine an ultraviolet purification system with another form of filtration since the UV radiation cannot neutralize chlorine, heavy metals, and other chemical contaminants that may be present in the water. Various membrane filters for sediment filtration, granular activated carbon filtering, reverse osmosis, and/or the like, can be used as a filtering device to reduce the presence of chemicals and other inorganic contaminants.

Mercury lamp-based ultraviolet radiation disinfection has several shortcomings when compared to deep ultraviolet (DUV) light emitting device (LED)-based technology, particularly with respect to certain disinfection applications. For example, in rural and/or off-grid locations, it is desirable for an ultraviolet purification system to have one or more of various attributes such as: a long operating lifetime, containing no hazardous components, not readily susceptible to damage, requiring minimal operational skills, not requiring special disposal procedures, capable of operating on local intermittent electrical power, and/or the like. Use of a DUV LED-based solution can provide a solution that improves one or more of these attributes as compared to a mercury vapor lamp-based approach. For example, in comparison to mercury vapor lamps, DUV LEDs: have substantially longer operating lifetimes (e.g., by a factor of ten); do not include hazardous components (e.g., mercury), which require special disposal and maintenance; are more durable in transit and handling (e.g., no filaments or glass); have a faster startup time; have a lower operational voltage; are less sensitive to power supply intermittency; are more compact and portable; can be used in moving devices; can be powered by photovoltaic (PV) technology, which can be installed in rural locations having no continuous access to electricity and having scarce resources of clean water; and/or the like.

A solution described in U.S. patent application Ser. No. 13/591,728 provides for treating a fluid, such as water. The solution first removes a set of target contaminants that may be present in the fluid using a filtering solution. The filtered fluid enters a disinfection chamber where it is irradiated by ultraviolet radiation to harm microorganisms that may be present in the fluid. An ultraviolet radiation source and/or the disinfection chamber can include one or more attributes configured to provide more efficient irradiation and/or higher disinfection rates.

### SUMMARY OF THE INVENTION

Aspects of the invention provide a fluid treatment system and method of treating fluid. The fluid treatment system can include a fluid transparency meter, which acquires data corresponding to an ultraviolet transparency of the fluid and a disinfection chamber within which a set of ultraviolet sources emit ultraviolet light onto the fluid located therein. The treatment system can include various features for mixing the fluid and/or recirculating the fluid for multiple ultraviolet light doses. A control system can manage a flow of the fluid through the fluid treatment system based on a disinfection dose delivered to the fluid.

A first aspect of the invention provides a fluid treatment system comprising: a fluid transparency meter for acquiring data corresponding to an ultraviolet transparency of the fluid; a disinfection chamber fluidly connected to the fluid transparency meter, wherein the disinfection chamber stores a volume of the fluid; a set of ultraviolet sources located within the disinfection chamber, wherein the set of ultraviolet sources emit ultraviolet light within the disinfection chamber; means for recirculating the fluid into at least one of: the fluid transparency meter or the disinfection chamber; means for mixing the fluid; and a control system for managing a flow of the fluid through the fluid treatment system based on a disinfection dose delivered to the fluid.

A second aspect of the invention provides a fluid treatment system comprising: a fluid transparency meter for acquiring data corresponding to an ultraviolet transparency of the fluid; a disinfection chamber fluidly connected to the fluid transparency meter, wherein the disinfection chamber stores a volume of the fluid; an illumination chamber located within the disinfection chamber and fluidly connected to an outlet of the disinfection chamber; an ultraviolet source located within the disinfection chamber, wherein the ultraviolet source is configured to emit ultraviolet radiation directed both into and out of the illumination chamber; means for mixing the fluid; and a control system for managing a flow of the fluid through the fluid treatment system based on a disinfection dose delivered to the fluid.

A third aspect of the invention provides a fluid treatment system comprising: a system inlet valve operable to selectively allow untreated fluid to enter the treatment system; a filtering component fluidly connected to the inlet valve, wherein the filtering component includes a plurality of filter outlet valves, at least one of the plurality of outlet valves selectively operable to allow the fluid to bypass a filter of the filtering component; a fluid transparency meter fluidly connected to the filtering component, wherein the fluid transparency meter acquires data corresponding to an ultraviolet transparency of the fluid; a disinfection chamber fluidly connected to the fluid transparency meter, wherein the disinfection chamber stores a volume of the fluid; a set of ultraviolet sources located within the disinfection chamber, wherein the set of ultraviolet sources emit ultraviolet light within the disinfection chamber; means for recirculating the fluid into at least one of: the fluid transparency meter or the disinfection chamber; a system outlet valve selectively operable to allow the fluid to exit the fluid treatment system; and a control system for managing a flow of the fluid through the fluid treatment system to provide a set of treatments to the fluid, wherein the control system: opens the inlet valve with the outlet valve closed to allow a desired amount of untreated fluid to enter the treatment system; closes the inlet valve and circulates the fluid through the treatment system to perform a set of treatments on the fluid; and opens the outlet valve while the inlet valve is closed to allow treated fluid to exit the treatment system.

Other aspects of the invention provide methods, systems, program products, and methods of using and generating each, which include and/or implement some or all of the actions described herein. The illustrative aspects of the invention are designed to solve one or more of the problems herein described and/or one or more other problems not discussed.

### BRIEF DESCRIPTION OF THE DRAWINGS

These and other features of the disclosure will be more readily understood from the following detailed description of the various aspects of the invention taken in conjunction with the accompanying drawings that depict various aspects of the invention.

FIG. 1 shows an illustrative germicidal effectiveness curve of ultraviolet radiation according to the prior art.

FIG. 2 shows an illustrative ultraviolet treatment system for treating a fluid within a chamber according to an embodiment.

FIG. 3 shows an illustrative portion of a treatment system according to another embodiment.

FIG. 4 shows an illustrative portion of a treatment system according to another embodiment.

FIG. 5 shows an illustrative portion of a treatment system according to still another embodiment.

FIG. 6 shows an illustrative portion of a treatment system according to yet another embodiment.

FIG. 7 shows an illustrative illumination chamber according to an embodiment.

FIG. 8 shows an illustrative treatment system according to an embodiment.

It is noted that the drawings may not be to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As indicated above, aspects of the invention provide a fluid treatment system and method of treating fluid. The fluid treatment system can include a fluid transparency meter, which acquires data corresponding to an ultraviolet transparency of the fluid and a disinfection chamber within which a set of ultraviolet sources emit ultraviolet light onto the fluid located therein. The treatment system can include various features for mixing the fluid and/or recirculating the fluid for multiple ultraviolet light doses. A control system can manage a flow of the fluid through the fluid treatment system based on a disinfection dose delivered to the fluid. In an illustrative embodiment, the control system circulates a fixed volume of fluid one or more times through the treatment system before allowing the fluid to exit the treatment system and subsequently introducing untreated fluid into the system.

As used herein, the terms “purification,” “decontamination,” “disinfection,” and their related terms mean treating a fluid so that it includes a sufficiently low number of contaminants (e.g., chemical, sediment, and/or the like) and microorganisms (e.g., virus, bacteria, and/or the like) so that the fluid is safe for a desired interaction with a human or other animal. For example, the purification, decontamination, or disinfection of water means that the resulting water has a sufficiently low level of microorganisms and other contaminants that a typical human or other animal can consume the water without suffering adverse effects from microorganisms and/or contaminants present in the water. A target level of microorganisms and/or contaminants can be defined, for example, by a standards setting organization, such as a governmental organization. As used herein, unless otherwise noted, the term “set” means one or more (i.e., at least one) and the phrase “any solution” means any now known or later developed solution.

Aspects of the invention are designed to improve the efficiency with which ultraviolet radiation is absorbed by a fluid. The improved design can provide a higher disinfection rate while requiring less power, making operation of the overall system more efficient. In an embodiment, the fluid is a liquid. In a particular embodiment, the liquid is water and the system is configured to provide a reduction of microorganism (e.g., bacterial and/or viral) contamination in the water by at least a factor of two. In a more particular embodiment, the system provides approximately 99.9% decontamination of the water.

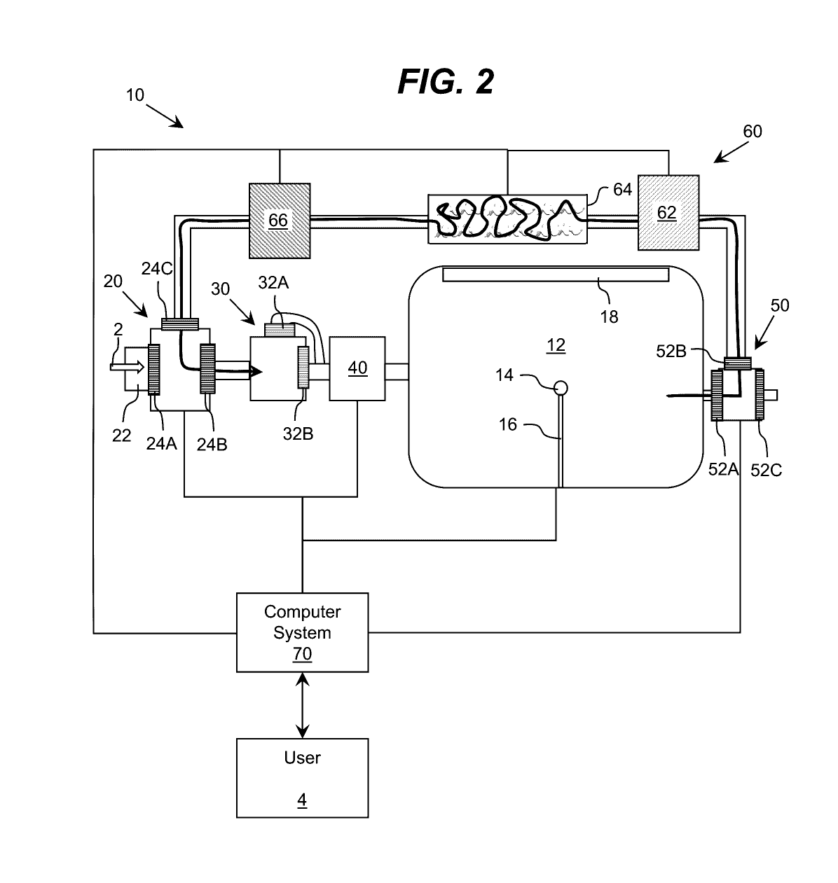

Turning to the drawings, FIG. 2 shows an illustrative ultraviolet treatment system 10 for treating a fluid 2 within a chamber 12 according to an embodiment. As illustrated, when being treated, the fluid 2 can pass through an inlet component 20, a filtering component 30, a transparency meter component 40, the chamber 12, an outlet component 50, and a recirculation component 60. The system 10 further includes a computer system 70, which can be configured to operate one or more of the other components 20, 30, 40, 50, 60 of the treatment system 10. Details of each of these components of the system 10 are further described herein.

Untreated fluid 2 can enter the treatment system 10 via a preliminary filter unit 22 located adjacent to a first inlet valve 24A of the inlet component 20. The filtered fluid can exit the inlet component 20 via a second inlet valve 24B upon which the fluid enters the filtering component 30. The filtering component 30 can include two valves 32A, 32B. In an embodiment, one valve, such as the valve 32A is utilized when the fluid requires additional filtering by the filtering component 30, while the other valve, such as the valve 32B, is utilized when the fluid does not require additional filtering. Regardless, after passing through the filtering component 30, the fluid enters the transparency meter component 40 before entering the chamber 12. The chamber 12 includes one or more ultraviolet sources 14 from which ultraviolet radiation can be emitted. In an embodiment, the ultraviolet source 14 is located in a central region (e.g., within +/−5% of the centroid of the interior volume) of the chamber 12.

In an embodiment, the chamber 12 is configured to hold a large volume of the fluid. For example, the chamber 12 can have a characteristic size (e.g., largest radius when the ultraviolet source 14 is centrally located within the chamber 12) that is larger than or comparable (e.g., within +/−5%) to the length of attenuation of ultraviolet light within the fluid being treated. In this case, the chamber 12 can have a size sufficient to significantly reduce or eliminate ultraviolet light absorbed by the chamber walls. For example, a distance between the ultraviolet source 14 and the interior wall located furthest away can be of the same order of magnitude as the absorption length of ultraviolet light within the fluid (e.g., water). An illustrative chamber 12 can be substantially spherical, with the characteristic size corresponding to the radius. An alternative illustrative chamber 12 can be cylindrical, with the characteristic size corresponding to the radius of the cylinder. An illustrative range of characteristic sizes for the chamber 12 is within a decimeter to a few meters. For a chamber 12 with UV reflective walls, the characteristic radius of the chamber 12 (where the characteristic radius is defined as a shortest distance from the ultraviolet source 14 and any chamber wall) can be comparable to one half of the attenuation length. However, it is understood that other chamber dimensions can be utilized.

The computer system 70 operates the corresponding valves 24A, 24B, 32A, 32B to regulate the flow of the fluid 2 through the inlet component 20, the filtering component 30, and the transparency meter component 40. Furthermore, the computer system 70 can receive feedback regarding one or more attributes of the fluid 2 from the corresponding components 20, 30, 40. For example, the inlet component 20 and/or an entrance into the filtering component 30 can include one or more sensors for acquiring data on the fluid to determine whether additional filtering is required when the fluid passes into the filtering component 30. In this case, the computer system 70 can receive data acquired by the sensors, and process the data to select the corresponding valve 32A, 32B of the filtering component 30 according to whether the data indicates that additional filtering is or is not required. For example, illustrative sensors include fluid transparency sensors, which are based on optical measurements. In an embodiment, the preliminary filter unit 22 can be utilized to filter large particles from the fluid, while the filtering component 30 can be configured to filter chemical and/or biological agents from the fluid. By only selectively utilizing the filters present in the filtering component 30, an operating life of these filters can be extended.

Furthermore, the computer system 70 can operate the transparency meter component 40 and receive feedback therefrom regarding a transparency of the fluid entering the chamber 12. In an illustrative embodiment, the transparency meter component 40 includes a transparency assembly, such as one of the transparency assemblies shown and described in U.S. patent application Ser. No. 14/157,874, which is hereby incorporated by reference. In response, the computer system 70 can adjust an intensity of the ultraviolet radiation utilized in the chamber 12 based on the transparency of the fluid. Furthermore, the computer system 70 can determine the disinfection dose delivered to the fluid based on the corresponding transparency. However, it is understood that the computer system 70 can utilized one or more additional attributes of the operation of the treatment system 10 and/or the fluid to determine a target level of intensity for the ultraviolet radiation. Additional attributes can include, for example: a rate of the fluid flow, which the computer system 70 can regulate using the valves 24A, 24B, 32A, 32B; a level of contamination of the fluid; and/or the like.

Upon startup of the treatment system 10, the computer system 70 can open valves 24A, 24B, 32A (to filter the fluid), while keeping all remaining valves closed. As a result, untreated fluid 2 will flow through the inlet component 20, filtering component 30, and transparency meter component 40 before entering the chamber 12. The computer system 70 can allow the fluid 2 to flow into the treatment system 10 until the chamber 12 has been filled. Once filled, the computer system 70 can close the valves 24A, 24B, 32A.

Within the chamber 12, the computer system 70 can operate a set of ultraviolet sources, such as an ultraviolet source 14, to deliver a target level of intensity of ultraviolet radiation for a target amount of time. As illustrated, in an embodiment, an ultraviolet source 14 can be positioned in approximately the center of the chamber 12 and can emit ultraviolet radiation in substantially all directions. To this extent, the ultraviolet source 14 is shown placed on a protrusion 16, which extends from a wall of the chamber 12 into the interior. However, it is understood that this is only illustrative, and other embodiments can include any combination of one or more ultraviolet sources 16 located in a desired position using any combination of solutions, including suspension from a top surface, mounted on one or more of the walls of the chamber 12 (in which case ultraviolet light can be emitted only in a direction away from the walls into the fluid), and/or the like.

The chamber 12 can include one or more additional features to improve sterilization treatment performed therein. For example, the chamber 12 is shown including an interior surface containing a photocatalytic material 18, such as titanium dioxide, carbon or silver doped titanium dioxide, and/or the like, located thereon. The photocatalytic material 18 can improve disinfection of the fluid using the ultraviolet radiation. In an embodiment, the photocatalytic material 18 has a high surface area. For example, the photocatalytic material 18 can include a powder or granules, which can provide a large surface area. Additionally, rather than being located on an interior surface of the chamber 12, the chamber 12 can include one or more structures located therein which include the photocatalytic material 18. Illustrative structures include a mesh element, a net element, a turbulence inducing element, and/or the like. Furthermore, it is understood that the chamber 12 can include one or more of such elements which are included to induce turbulence and/or deliver ultraviolet radiation, which do not include photocatalytic material 18.

After an initial ultraviolet treatment within the chamber 12, the computer system 70 can open outlet valves 52A, 52B on the outlet component 50 to enable the fluid to circulate through a remainder of the treatment system 10. In an embodiment, the computer system 70 also can open inlet valves 24A, 24B and one or more of the filter valves 32A, 32B to allow untreated fluid 2 to enter the treatment system 10 (e.g., upon startup when no fluid has entered the treatment system 10 beyond the chamber 12). As illustrated, the outlet valve 52B enables the fluid to flow into recirculation component 60 of the treatment system 10 which eventually reintroduces the fluid to the start of the treatment system 10 via the inlet valve 24C.

Prior to being reintroduced, the fluid can undergo one or more additional treatments within the recirculation component 60. For example, the fluid can enter a supplemental treatment unit 62, which can perform one or more additional treatments on the fluid. Illustrative treatments include, for example, filtering, chemical treatment, physical treatment, and/or the like. In an illustrative embodiment, such a treatment can include introducing ozone into the fluid (e.g., water), which can assist in harming bacteria presented in the fluid. Additionally, the supplemental treatment unit 62 can introduce a chemical to treat the water, which can be subsequently filtered by the filtering component 30. For example, the chemical treatment can introduce chlorine, which is subsequently removed from the fluid (which may be after one or more cycles of the fluid through the system) by the filtering component 30. Still further, embodiments of the supplemental treatment unit 62 can thermally treat the fluid (e.g., heat the fluid to a temperature that harms one or more contaminants present therein).

Additionally, the fluid can pass through a mixing unit 64 in which a high level of turbulence can be introduced into the flow of the fluid. Such turbulence can provide a mixing of the fluid. The mixing unit 64 can include any configuration for introducing turbulence into the fluid flow. For example, as illustrated, the mixing unit 64 can include a mixing chamber within which one or more mixing elements, each of which can be moving, stationary, independently powered, powered by the fluid flow, and/or the like, can be located. Motion of the fluid can be operated by a pumping unit 66, which can utilize any solution. It is understood that the combination and relative arrangement of the units 62, 64, 66 of the recirculation component 60 are only illustrative. To this extent, in other embodiments, the recirculation component 60 can include any combination of various units, which can be arranged in any manner and perform any combination of treatment(s) and/or action(s) on the fluid. In a particular embodiment, the pumping unit 66, and/or an additional pumping unit 66, can be located anywhere within or between the inlet component 20 and the outlet component 50.

In an embodiment, the computer system 70 can operate the various components to allow the fluid to circulate through the treatment system 10 until a target ultraviolet dose has been delivered to the fluid. In this case, the computer system 70 can open valves 24B, 24C, 52A, 52B, and one or both of valves 32A, 32B while valves 24A, and 52C are closed to allow the fluid to circulate through the treatment system 10 via the pumping unit 66. In an embodiment, the target ultraviolet dose can be determined by the computer system 70. For example, the computer system 70 can receive data corresponding to a transparency of the fluid from the transparency meter component 40 and correlate the transparency of the fluid with a required ultraviolet treatment. In an embodiment, the recirculation component 60, such as the supplemental treatment unit 62, can include one or more sensors for providing feedback to the computer system 70 regarding the fluid. For example, the supplemental treatment unit 62 can include one or more sensors which can provide data for use by the computer system 70 in evaluating contamination of the fluid. In an embodiment, such sensors include a set of fluorescent sensors, which can be operated by the computer system 70 to provide information relating to a quality of the sterilization achieved for the fluid. The computer system 70 can use such fluorescence information to determine the target ultraviolet dose, and whether any additional ultraviolet treatment is required. In still another embodiment, the computer system 70 can include an interface, which enables a user 4 (e.g., a human user or another computer system) to identify the target ultraviolet dose.

The treatment system 10 can achieve a target ultraviolet dose by varying an intensity of the ultraviolet radiation emitted within the chamber 12 and/or by adjusting a number of times the fluid is circulated through the treatment system 10. To this extent, the computer system 70 can vary the intensity of the ultraviolet radiation emitted by the set of ultraviolet sources 14 within the treatment chamber 12 based on the target ultraviolet dose and/or the transparency of the fluid. The intensity of the ultraviolet radiation can be varied by selectively operating some or all of the set of ultraviolet sources 14, operating ultraviolet source(s) in pulsed or continuous mode, varying an amount of power provided to ultraviolet source(s), and/or the like. In addition, the computer system 70 can vary a total dose of ultraviolet radiation provided within the chamber 12 for each circulation of the fluid by varying a speed at which the fluid is circulating, e.g., by varying operation of the pumping unit 66 (e.g., adjusting a speed, operating in pulsed mode, and/or the like).

Once the fluid treatment is complete (e.g., the target dose of ultraviolet radiation has been delivered), the computer system 70 can operate the valves to allow the fluid to exit the treatment system 10. For example, the computer system 70 can close the outlet valve 52B and open the outlet valve 52C to allow the fluid to exit the treatment system 10. In an embodiment, the treatment system 10 can include an additional pumping unit 66 and/or the pumping unit 66 in a different location to facilitate the flow of the fluid in this valve configuration. To this extent, it is understood that the treatment system 10 includes any additional fluid pumps and/or venting, which can be designed to route the fluid through the treatment system 10. For example, embodiments can include the pumping unit 66 and/or one or more additional pumping units, incorporated into and/or located near the filtering component 30, the outlet component 50, and/or the like. It is further understood that as treated fluid is being removed from the treatment system 10, a gas can be pumped into and/or allowed to enter the treatment system 10, e.g., the chamber 12, to avoid formation of low pressure within the treatment system 10.

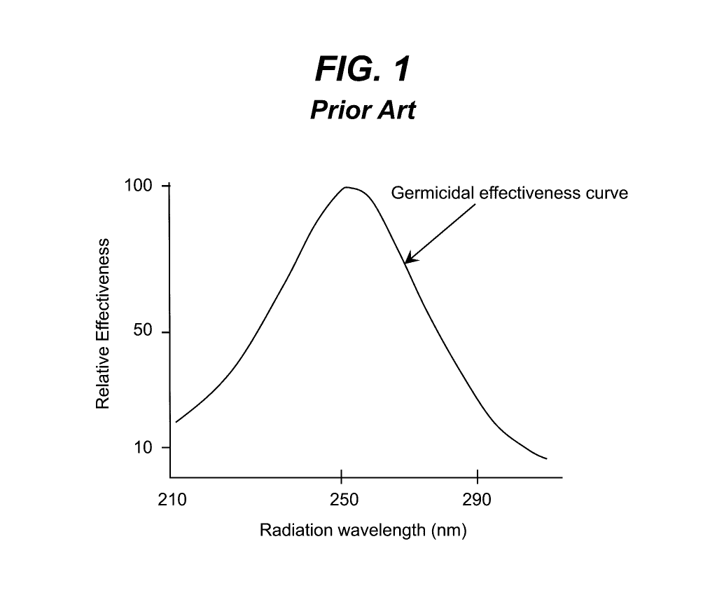

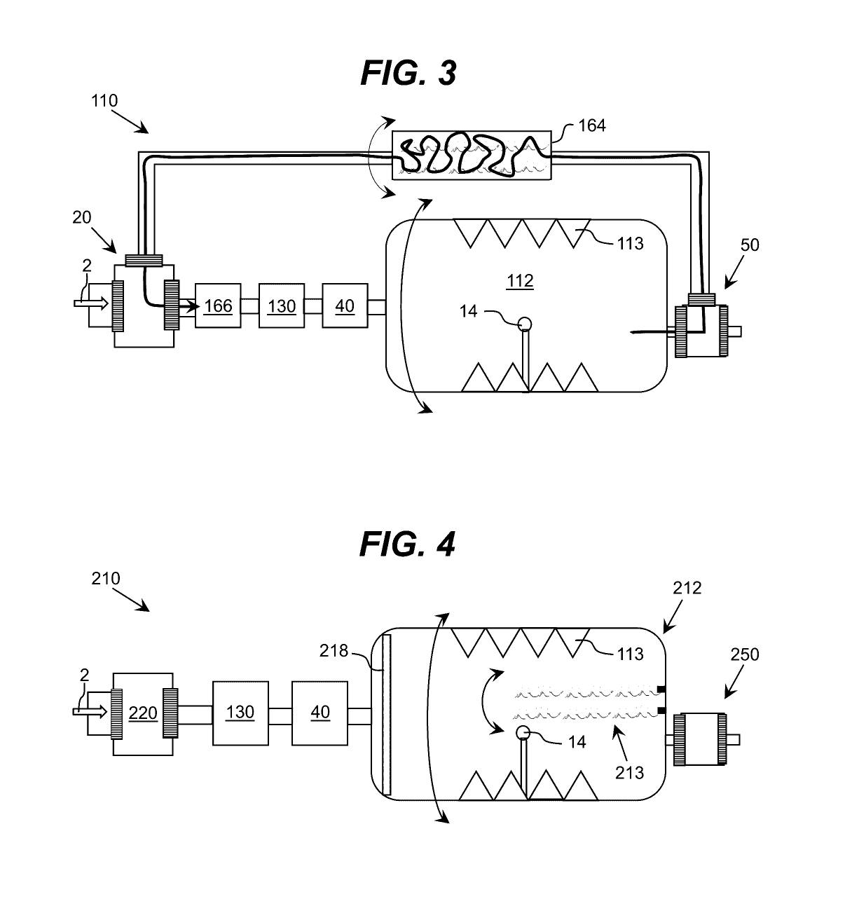

It is understood that embodiments of the treatment system 10 can include any combination of numerous variations from the treatment system 10 shown in FIG. 2. For example, FIG. 3 shows an illustrative portion of a treatment system 110 according to another embodiment. In this case, the treatment system 110 includes an inlet component 20, a transparency meter component 40, and an outlet component 50, each of which is configured to operate in the same manner as described in conjunction with FIG. 1. However, the treatment system 110 includes a filtering component 130, which does not include any valves for selective operation thereof. In contrast, the fluid will flow through the filter(s) located therein on each pass through the treatment system 110. Furthermore, the treatment system 110 includes a pumping unit 166 located between the inlet component 20 and the filtering component 130.

Additionally, each of the chamber 112 and the mixing unit 164 is capable of being rotated (e.g., under the control of the computer system 70 shown in FIG. 1) about its main axis. The rotational motion can be configured to increase mixing of the fluid located therein. In an embodiment, the chamber 112 and/or the mixing unit 164 can further include a set of mixing elements 113, which are located on an interior surface of the corresponding chamber 112 or mixing unit 164, and which can further encourage mixing of the fluid during rotation of the chamber 112 or mixing unit 164. It is understood that while the treatment system 110 is shown including both a chamber 112 and a mixing unit 164 capable of rotation, embodiments can include only one of the chamber 112 or the mixing unit 164, which is capable of rotation.

FIG. 4 shows an illustrative portion of a treatment system 210 according to another embodiment. In this case, the treatment system 210 does not include a recirculation component 60 (FIG. 1). As a result, the inlet component 220 and the outlet component 250 are implemented with only two valves, which can be operated by a computer system 70 (FIG. 1) as described herein. Additionally, the chamber 212 is shown including additional components for treating the fluid therein. For example, the chamber 212 is shown including a pair of mixing elements 213. The mixing elements 213 can be rotated about a main axis by the computer system 70 as illustrated. Alternatively, the mixing elements 213 can be fixed to a side of the chamber 212 and rotate when the chamber 212 is rotated. Regardless, it is understood that the number, size, shape, and locations of the mixing elements 213 are only illustrative, and embodiments of the chamber 212 can include any combination of one or more mixing elements 213 located in any location(s) of the chamber 212. Additionally, the chamber 212 is shown including a mesh structure 218, which can be mounted to the chamber 212 and through which the fluid will flow. The mesh structure 218 can be formed of and/or coated with a photocatalytic material described herein.

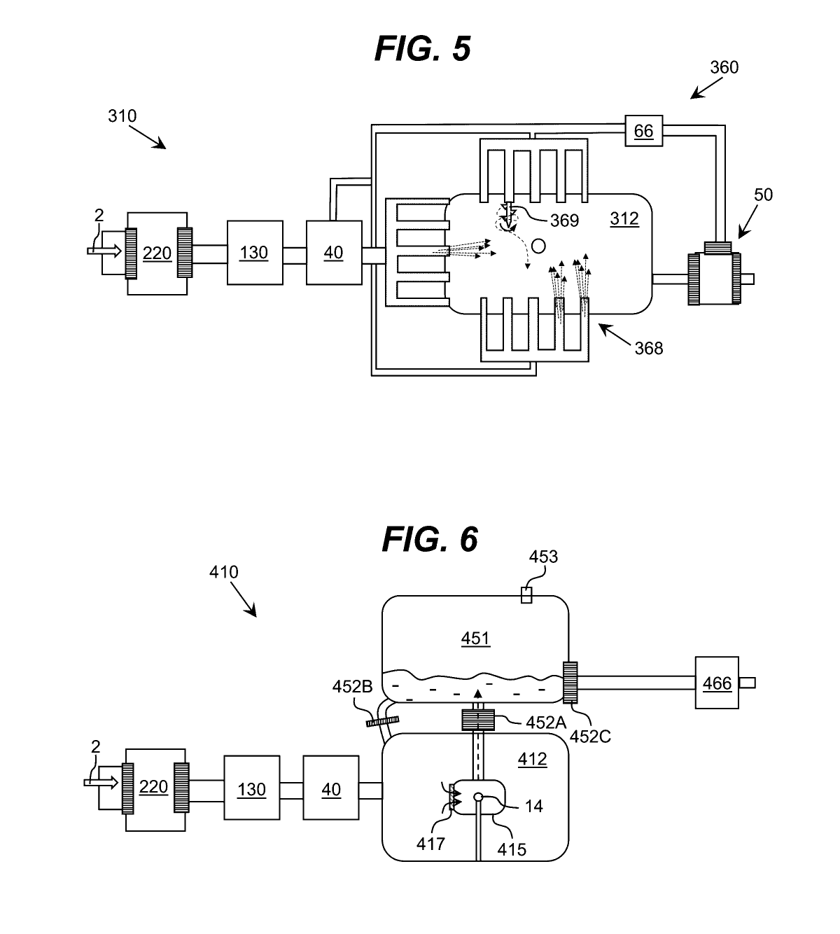

FIG. 5 shows an illustrative portion of a treatment system 310 according to still another embodiment. In this embodiment, the recirculation component 360 includes a pumping unit 66 and corresponding piping, which is configured to inject fast jets of the fluid from a plurality of nozzles 368 into the chamber 312. The computer system 70 can regulate the speed of the jets to facilitate efficient mixing of the fluid within the chamber 312, e.g., by varying a number of nozzles 368 open, varying a size of the nozzle 368 openings, and/or the like. Such speed can depend on the type of the fluid being sterilized. In an embodiment, a flow rate of the jets is at least several (e.g., 3-10) liters per minute. As illustrated, the nozzles 368 can be arranged into one or more groups of nozzles, each of which can be located in one of various locations throughout the chamber 312. Use of the nozzles 368 can increase mixing and turbulence of the fluid within the chamber 312. Furthermore, as illustrated by mixing unit 369, one or more of the nozzles 368 can include an associated mixing unit 369, which can induce additional turbulence within the jet of fluid exiting the nozzle 368 and within the chamber 312. As illustrated, an embodiment of the mixing unit 369 can include an elongate member with a plurality of fins extending therefrom. The fins can be located at different locations along the length and around the perimeter of the mixing unit 369. In this case, the fins can cause the fluid exiting the nozzle 368 to be redirected.

As further illustrated, some or all of the recirculated fluid can be directed to the transparency meter component 40, which can provide transparency data for evaluation by the computer system 70 (FIG. 2). In an alternative embodiment, a transparency sensor can be located in the chamber 312, at one or more of the nozzles 368, and/or the like. In further embodiments, the computer system 70 can recirculate the fluid to deliver a target level of ultraviolet radiation, which can be selected, e.g., based on the transparency data acquired prior to the fluid initially entering the chamber 312, by a user 4 (FIG. 2), and/or the like.

FIG. 6 shows an illustrative portion of a treatment system 410 according to yet another embodiment. In this embodiment, the chamber 412 includes a smaller illumination chamber 415 located therein. The illumination chamber 415 can be fluidly attached to the chamber 412 via an inlet valve 417, and fluidly attached to a storage chamber 451 via an outlet valve 452A. During operation of the treatment system 410, fluid is treated with a dose of ultraviolet radiation within the illumination chamber 415 prior to entering the storage chamber 451. In an embodiment, the storage chamber 451 has a volume at least as large as a volume of the chamber 412. Once a target dose of ultraviolet radiation has been delivered to the fluid, the outlet valve 452C can be opened and the fluid can be pumped from the system using a pumping unit 466. When an additional dose of ultraviolet radiation is required, the fluid can be returned to the chamber 412 via the outlet valve 4526.

During operation, the computer system 70 (FIG. 2) can operate the various valves and ultraviolet source 14 to deliver a target dose of ultraviolet radiation to the fluid. In an embodiment, the computer system 70 can deliver one or more doses of ultraviolet radiation to smaller portions of the fluid located within the illumination chamber 415. For example, the computer system 70 can open the inlet valve 417 to allow fluid to enter the illumination chamber 415. Once the illumination chamber 415 is filled with the fluid, the computer system 70 can close the inlet valve 417 and radiate the fluid within the illumination chamber 415 with ultraviolet light emitted by the ultraviolet source 14. After delivering a target dose of ultraviolet radiation, the computer system 70 can open the outlet valve 452A and the fluid can enter the storage chamber 451. The fluid can be removed from the illumination chamber 415 before the computer system 70 closed the outlet valve 452A and opens the inlet valve 417 to allow additional fluid to flow into the illumination chamber 415 for treatment. This process can be repeated until all of the fluid within the treatment system 410 has been treated with a target dose of ultraviolet radiation.

It is understood that this process is only illustrative of various processes, which can be implemented to treat fluid within the treatment system 410. For example, in another embodiment, the computer system 70 can operate the valves 417, 452A, 452B to regulate a velocity at which the fluid is circulating through the chambers 412, 415, 451. Additionally, the computer system 70 can allow new fluid to enter the illumination chamber 415 prior to all of the previously treated fluid having left the illumination chamber 415. Regardless, the fluid can be circulated through the treatment system 410 one or more times to deliver a target dose of ultraviolet radiation, which can be determined using any solution described herein.

Furthermore, it is understood that one or more features of the treatment system 410 can be modified in embodiments. For example, the valve 452B can return fluid to the transparency meter component 40 or the filtering component 130 rather than directly to the chamber 412. Additionally, the chamber 412 and/or the storage chamber 451 can include one or more additional devices, such as a transparency meter, a pumping unit, a filtering unit, an additional treatment unit, and/or the like, which can provide feedback data to the computer system 70, provide additional treatment to the fluid, provide a desired flow of the fluid, and/or the like. In an embodiment, the illumination chamber 415 is formed of an ultraviolet transparent material, which can allow at least a portion of the ultraviolet light to escape into the fluid present in the outer treatment chamber 412. Illustrative types of ultraviolet transparent materials include a fluoropolymer film, sapphire based wall, fused silica, and/or the like. It is understood that while the various fluid inlets for the chambers 412, 415, and 451 are shown having a particular relative arrangement, any arrangement can be implemented to provide a desired flow of fluid through the treatment system 410 and each of the chambers 412, 415, 451.

In each of the embodiments described herein, one or more of the corresponding chambers 412, 415, 451 can be only partially filled with the fluid during treatment of the fluid. In an embodiment, one or more of the chambers 412, 415, 451 can include a vent unit 453, which can be operated by the computer system 70 to maintain a target pressure therein. For example, the vent unit 453 can be operated by the computer system 70 to selectively introduce and/or remove air from the corresponding chamber 412, 415, 451 using any solution. Alternatively, the vent system 453 can be configured to automatically introduce air into and/or remove air from a chamber 412, 415, 451 in response to changes in the pressure present within the chamber 412, 415, 451. Such a vent unit 453 can comprise, for example, a pressure release valve. Flow of the fluid through a treatment system described herein can be managed through operation of the pumping unit(s) and/or vent unit(s) described herein. In this case, the pumping unit(s) and/or vent unit(s) can be operated to create pressure differences to cause fluid to flow from one chamber to another when the corresponding valve(s) are opened. In additional embodiments, other approaches, such as gravity flow, and/or the like, can be utilized to move the fluid through the treatment system.

As described herein, various aspects of a treatment system can induce turbulent flow of the fluid in portions of the system. In an embodiment, when a smaller illumination chamber 415 is utilized, the illumination chamber 415 is configured to substantially eliminate turbulent flow. For example, one or more features of the inlet valve 417 and/or the illumination chamber 415 can be configured to cause a laminar flow of the fluid through the illumination chamber 415.

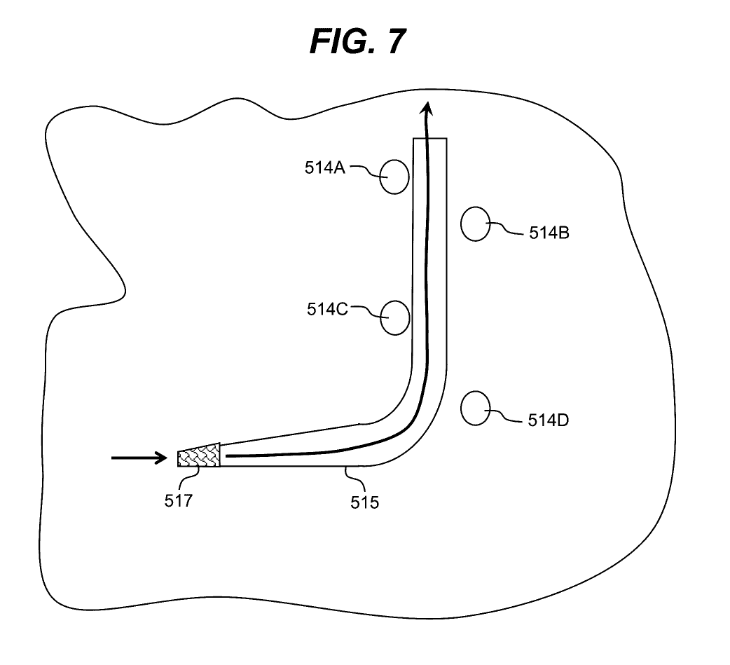

FIG. 7 shows an illustrative illumination chamber 515 according to an embodiment. In this case, the illumination chamber 515 has an elongated pipe shape, where the fluid enters the illumination chamber 515 through an inlet 517 configured to cause the fluid to have a laminar flow through the illumination chamber 515. For example, the inlet 517 can comprise a porous material, such as, for example, porous titanium, porous glass, porous plastic, and/or the like. Similarly, the inlet 517 can have a showerhead form, which includes many small holes. As the fluid flows through the illumination chamber 515, ultraviolet radiation emitted by a set of ultraviolet sources 514A-514D can deliver a dose of ultraviolet radiation to the fluid. As illustrated, the set of ultraviolet sources 514A-514D can be located outside a flow path of the fluid within the illumination chamber 515 to avoid disturbing the fluid flow. In an embodiment, the illumination chamber 515 is formed of an ultraviolet transparent material, and the set of ultraviolet sources 514A-514D are located adjacent to and/or mounted to (e.g., embedded in) the illumination chamber 515 to direct ultraviolet radiation into the interior of the illumination chamber 515. Furthermore, some or all of the ultraviolet radiation can be emitted outside of the illumination chamber 515 into fluid present in a surrounding treatment chamber, such as the treatment chamber 412 (FIG. 6). By treating fluid present within and outside of the illumination chamber 515, an efficiency of the overall treatment system can be improved.

It is understood that a treatment system described herein can include any combination of features shown and described in conjunction with FIGS. 2-7. To this extent, a feature that is only shown in some of these figures can be incorporated into the treatment systems illustrated in the other features unless such a feature is explicitly described as not being present in the corresponding embodiment.

Regardless, in each of the embodiments, a computer system 70 can be utilized to manage the flow of the fluid through the treatment system and manage the treatment(s) performed on the fluid present therein. To this extent, the computer system 70 can be configured to operate the various devices located therein, including the valves, ultraviolet source(s), pump(s), filter(s), alternative treatment device(s), evaluation devices, and/or the like. In an embodiment, the computer system 70 configures a rate of circulation of the fluid through the treatment system and/or intensity of the ultraviolet source to provide a target disinfection rate. Such control can be configured according to the type of fluid requiring disinfection. In particular, the computer system 70 can account for a transparency of the fluid, a viscosity of the fluid, and/or the like, to calculate the circulation and/or ultraviolet intensity values that will provide the desired sterilization.

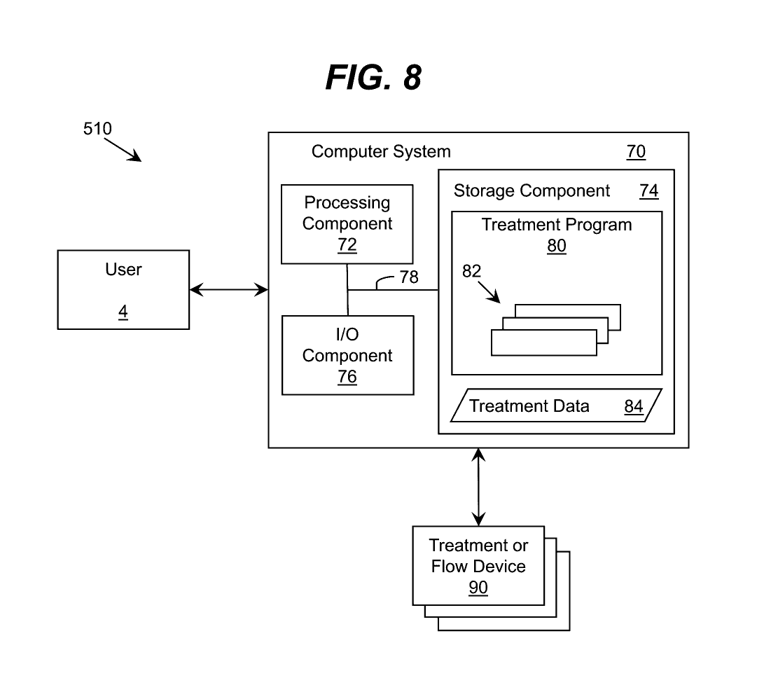

FIG. 8 shows an illustrative treatment system 510 according to an embodiment. To this extent, the treatment system 510 includes a computer system 70 that can perform a process described herein in order to treat a fluid flowing through the treatment system as described herein. In particular, the computer system 70 is shown including a treatment program 30, which makes the computer system 70 operable to operate various treatment or flow devices 90 (e.g., components, units, sensors, valves, ultraviolet sources, and/or the like) included in the treatment system 510 to treat the fluid by performing a process described herein.

The computer system 70 is shown including a processing component 72 (e.g., one or more processors), a storage component 74 (e.g., a storage hierarchy), an input/output (I/O) component 76 (e.g., one or more I/O interfaces and/or devices), and a communications pathway 78. In general, the processing component 72 executes program code, such as the treatment program 80, which is at least partially fixed in storage component 74. While executing program code, the processing component 72 can process data, which can result in reading and/or writing transformed data from/to the storage component 74 and/or the I/O component 76 for further processing. The pathway 78 provides a communications link between each of the components in the computer system 70. The I/O component 76 can comprise one or more human I/O devices, which enable a human user 4 to interact with the computer system 70 and/or one or more communications devices to enable a system user 4 to communicate with the computer system 70 using any type of communications link. To this extent, the treatment program 80 can manage a set of interfaces (e.g., graphical user interface(s), application program interface, and/or the like) that enable human and/or system users 4 to interact with the treatment program 30. Furthermore, the treatment program 30 can manage (e.g., store, retrieve, create, manipulate, organize, present, etc.) the data, such as treatment data 84, using any solution.

In any event, the computer system 70 can comprise one or more general purpose computing articles of manufacture (e.g., computing devices) capable of executing program code, such as the treatment program 80, installed thereon. As used herein, it is understood that “program code” means any collection of instructions, in any language, code or notation, that cause a computing device having an information processing capability to perform a particular action either directly or after any combination of the following: (a) conversion to another language, code or notation; (b) reproduction in a different material form; and/or (c) decompression. To this extent, the treatment program 80 can be embodied as any combination of system software and/or application software.

Furthermore, the treatment program 80 can be implemented using a set of modules 82. In this case, a module 82 can enable the computer system 70 to perform a set of tasks used by the treatment program 80, and can be separately developed and/or implemented apart from other portions of the treatment program 80. As used herein, the term “component” means any configuration of hardware, with or without software, which implements the functionality described in conjunction therewith using any solution, while the term “module” means program code that enables a computer system 70 to implement the actions described in conjunction therewith using any solution. When fixed in a storage component 74 of a computer system 70 that includes a processing component 72, a module is a substantial portion of a component that implements the actions. Regardless, it is understood that two or more components, modules, and/or systems may share some/all of their respective hardware and/or software. Furthermore, it is understood that some of the functionality discussed herein may not be implemented or additional functionality may be included as part of the computer system 70.

When the computer system 70 comprises multiple computing devices, each computing device can have only a portion of the treatment program 80 fixed thereon (e.g., one or more modules 82). However, it is understood that the computer system 70 and the treatment program 80 are only representative of various possible equivalent computer systems that may perform a process described herein. To this extent, in other embodiments, the functionality provided by the computer system 70 and the treatment program 80 can be at least partially implemented by one or more computing devices that include any combination of general and/or specific purpose hardware with or without program code. In each embodiment, the hardware and program code, if included, can be created using standard engineering and programming techniques, respectively.

Regardless, when the computer system 70 includes multiple computing devices, the computing devices can communicate over any type of communications link. Furthermore, while performing a process described herein, the computer system 70 can communicate with one or more other computer systems using any type of communications link. In either case, the communications link can comprise any combination of various types of optical fiber, wired, and/or wireless links; comprise any combination of one or more types of networks; and/or utilize any combination of various types of transmission techniques and protocols.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A fluid treatment system comprising:
a fluid transparency meter for acquiring data corresponding to an ultraviolet transparency of the fluid;
a disinfection chamber fluidly connected to the fluid transparency meter, wherein the disinfection chamber stores a volume of the fluid;
a set of ultraviolet sources located within the disinfection chamber, wherein the set of ultraviolet sources emit ultraviolet light within the disinfection chamber;
means for recirculating the fluid into at least one of: the fluid transparency meter or the disinfection chamber;
means for mixing the fluid; and
a control system for managing a flow of the fluid through the fluid treatment system based on a disinfection dose delivered to the fluid.

2. The system of claim 1, wherein the set of ultraviolet sources emit ultraviolet light into the chamber from a central region of the chamber.

3. The system of claim 1, wherein the means for recirculating the fluid includes means for reintroducing at least a portion of the fluid into the fluid transparency meter, wherein the control system uses ultraviolet transparency data of the fluid to dynamically determine the disinfection dose.

4. The system of claim 1, further comprising a set of filtering components for filtering the fluid within the treatment system, wherein at least one filtering component is configured with a plurality of outlet valves, at least one of the plurality of outlet valves allowing the fluid to bypass a filter of the at least one filtering component.

5. The system of claim 1, wherein the means for mixing the fluid includes a set of mixing elements located within the disinfection chamber.

6. The system of claim 5, wherein the means for mixing the fluid further includes means for rotating the disinfection chamber.

7. The system of claim 1, wherein the means for mixing the fluid includes a plurality of nozzles for introducing jets of the fluid into the disinfection chamber.

8. The system of claim 1, further comprising an illumination chamber located within the disinfection chamber, wherein the set of ultraviolet sources are configured to emit ultraviolet radiation directed both into and out of the illumination chamber.

9. The system of claim 8, wherein the illumination chamber is configured to induce a laminar flow of the fluid through the illumination chamber.

10. The system of claim 1, further comprising:
an inlet component including an inlet valve operable by the control system to allow untreated fluid to selectively enter the treatment system; and
an outlet component including an outlet valve operable by the control system to allow treated fluid to selectively exit the treatment system, wherein the control system:
opens the inlet valve and closes the outlet valve to allow untreated fluid to enter the treatment system;
closes the inlet valve and circulates the fluid through the treatment system to perform a set of desired treatments on the fluid; and
opens the outlet valve to allow treated fluid to exit the treatment system.

11. A fluid treatment system comprising:
a fluid transparency meter for acquiring data corresponding to an ultraviolet transparency of the fluid;
a disinfection chamber fluidly connected to the fluid transparency meter, wherein the disinfection chamber stores a volume of the fluid;
an illumination chamber located within the disinfection chamber and fluidly connected to an outlet of the disinfection chamber;
an ultraviolet source located within the disinfection chamber, wherein the ultraviolet source is configured to emit ultraviolet radiation directed both into and out of the illumination chamber;
means for mixing the fluid; and
a control system for managing a flow of the fluid through the fluid treatment system based on a disinfection dose delivered to the fluid.

12. The system of claim 11, wherein the means for mixing the fluid includes a plurality of nozzles for introducing jets of the fluid into the disinfection chamber.

13. The system of claim 12, wherein the illumination chamber is configured to induce a laminar flow of the fluid through the illumination chamber.

14. The system of claim 11, further comprising a storage chamber fluidly attached to the outlet of the disinfection chamber, wherein fluid enters the storage chamber after treatment in the illumination chamber.

15. The system of claim 11, further comprising means for recirculating the fluid into at least one of: the fluid transparency meter or the disinfection chamber.

16. A fluid treatment system comprising:
a system inlet valve operable to selectively allow untreated fluid to enter the treatment system;
a filtering component fluidly connected to the inlet valve, wherein the filtering component includes a plurality of filter outlet valves, at least one of the plurality of outlet valves selectively operable to allow the fluid to bypass a filter of the filtering component;
a fluid transparency meter fluidly connected to the filtering component, wherein the fluid transparency meter acquires data corresponding to an ultraviolet transparency of the fluid;
a disinfection chamber fluidly connected to the fluid transparency meter, wherein the disinfection chamber stores a volume of the fluid;
a set of ultraviolet sources located within the disinfection chamber, wherein the set of ultraviolet sources emit ultraviolet light within the disinfection chamber;
means for recirculating the fluid into at least one of: the fluid transparency meter or the disinfection chamber;
a system outlet valve selectively operable to allow the fluid to exit the fluid treatment system; and
a control system for managing a flow of the fluid through the fluid treatment system to provide a set of treatments to the fluid, wherein the control system:
opens the inlet valve with the outlet valve closed to allow a desired amount of untreated fluid to enter the treatment system;
closes the inlet valve and circulates the fluid through the treatment system to perform a set of treatments on the fluid; and
opens the outlet valve while the inlet valve is closed to allow treated fluid to exit the treatment system.

17. The system of claim 16, further comprising an illumination chamber located within the disinfection chamber, wherein the set of ultraviolet sources are configured to emit ultraviolet radiation directed both into and out of the illumination chamber.

18. The system of claim 17, wherein the illumination chamber is configured to induce a laminar flow of the fluid through the illumination chamber.

19. The system of claim 16, a set of mixing elements located within the disinfection chamber, wherein the set of mixing elements induce turbulence in the fluid present within the disinfection chamber.

20. The system of claim 19, wherein the set of mixing elements includes a plurality of nozzles for introducing jets of the fluid into the disinfection chamber.
